(19) United States
(12) Patent Application Publication
(10) Pub. No.: US 2005/0144223 A1
(43) Pub. Date: Jun. 30, 2005

(54) Bottom-up cache structure for storage servers

(75) Inventors: Qing Yang, Saunderstown, RI (US); Ming Zhang, Kingstown, RI (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Rhode Island Board of Governors for Higher Education, Providence, RI (US)

(21) Appl. No.: 10/970,671

(22) Filed: Oct. 20, 2004

Related U.S. Application Data
(60) Provisional application No. 60/512,728, filed on Oct. 20, 2003.

(51) Int. Cl. G06F 12/00

(52) U.S. Cl. 709/203; 711/122

(57) ABSTRACT

A networked storage server has a bottom-up caching hierarchy. The bottom level cache is located on an embedded controller that is a combination of network interface card (NIC) and host bus adapter (HBA). Storage data coming from or going to network are cached at this bottom level cache and metadata related to these data are passed to server host for processing. When cached data exceed the capacity of the bottom level cache, data are moved to the host memory that is usually much larger than the memory on the controller. For storage read requests from the network, most data are directly passed to the network through the bottom level cache from the storage device such as a hard drive or RAID. Similarly for storage write requests from the network, most data are directly written to the storage device through the bottom level cache without copying them to the host memory. Such data caching at the controller level dramatically reduces bus traffic resulting in great performance improvement for networked storages.

### CROSS-REFERENCES TO RELATED APPLICATIONS

The present application claims priority from U.S. Provisional Patent Application No. 60/512,728, filed Oct. 20, 2003, which is incorporated by reference.

### BACKGROUND OF THE INVENTION

The present invention relates to storage servers that are coupled to a network.

Data is the underlying resources on which all computing processes are based. With the recent explosive growth of the Internet and e-business, the demand on data storage systems has increased tremendously. The data storage system includes one or more storage servers and one or more clients or user systems. The storage servers handles the clients' read and write requests (also referred to as I/O requests). Much research has been devoted to enable the storage servers to handle the I/O requests faster and more efficiently.

The I/O request processing capability of the storage server has improved dramatically over the past decade as a result of technological advances that led to dramatic increase in CPU performance and network speed. Similarly, throughput of data storage systems have also improved greatly due to improvement in data management technologies at the storage device level, such as RAID (Redundant Array of Inexpensive Disks), and the use of extensive caching.

In contrast, the performance increase of system interconnect such as PCI bus has not kept pace with the advances in the CPU and peripherals during the same time period. As a result, the system interconnect has become the major performance bottleneck for high performance servers. This bottleneck problem has been widely realized by the computer architecture and system community. Extensive research has been done to address this bottleneck problem. One notable research effort in this area relates to increasing the bandwidth of system interconnects by replacing PCI with PCI-X or InfiniBand™. The PCI-X stands for “PCI extended,” and is an enhanced PCI bus that improves upon the speed of PCI from 133 MBps to as much as 1 GBps. The InfiniBand™ technology uses a switch fabric as opposed to a shared bus to provide a higher bandwidth.

### BRIEF SUMMARY OF THE INVENTION

The embodiments of the present invention relate to storage servers having an improved caching structure that minimizes data traffic over the system interconnects. In the storage server, the bottom level cache (e.g., RAM) is located on an embedded controller that combines the functions of a network interface card (NIC) and storage device interface (e.g., host bus adapter). Storage data received from or to be transmitted to a network are cached at this bottom level cache and only metadata related to these storage data are passed to the CPU system (also referred to as “main processor”) of the server for processing.

When cached data exceeds the capacity of the bottom level cache, data are moved to the host RAM that is usually much larger than the RAM on the controller. The cache on the controller is referred to as a level-1 (L-1) cache, and that on the main processor as a level-2 (L-2) cache. This new system is referred to as a bottom-up cache structure (BUCS) in contrast to a traditional top-down cache where the top-level cache is the smallest and fastest, and the lower in the hierarchy the larger and slower the cache.

In one embodiment, a storage server coupled to a network includes a host module including a central processor unit (CPU) and a first memory; a system interconnect coupling the host module; and an integrated controller including a processor, a network interface device that is coupled to the network, a storage interface device coupled to a storage subsystem, and a second memory. The second memory defines a lower-level cache that temporarily stores storage data that is to be read out to the network or written to the storage subsystem, so that a read or write request can be processed without loading the storage data into an upper-level cache defined by the first memory.

In another embodiment, a method for managing a storage server that is coupled to a network comprises receiving an access request at the storage server from a remote device via the network, the access request relating to storage data. The storage data associated with the access request is stored at a lower-level cache of an integrated controller of the storage server in response to the access request without storing the storage data in an upper-level cache of a host module of the storage server, where the integrated controller has a first interface coupled to the network and a second interface coupled to a storage subsystem.

The access request is a write request. Metadata associated with the access request is sent to the host module via a system interconnect while keeping the storage data at the integrated controller. The method further includes generating a descriptor at the host module using the metadata received from the integrated controller; receiving the descriptor at the integrated controller; associating the descriptor to the storage data at the integrated controller to write the storage data to an appropriate storage location in the storage subsystem via the second interface of the integrated controller.

The access request is a read request and the storage data is obtained from the storage subsystem via the second interface. The method further includes sending the storage data to the remote device via the first interface without first forwarding the storage data to the host module.

In another embodiment, an integrated controller for a storage controller provided in a storage server includes a processor to process data; a memory to define a lower-level cache; a first interface coupled to a remote device via a network; a second interface coupled to a storage subsystem. The integrated controller is configured to temporarily store write data associated with a write request received from the remote device at the lower-level cache and then send the write data to the storage subsystem via the second interface without having stored the write data to an upper-level cache associated with a host module of the storage server.

In yet another embodiment, a computer readable medium includes a computer program for handling access requests received at a storage server from a remote device via a network. The computer program comprises code for receiving an access request at the storage server from the remote device via the network, the access request relating to storage data; and storing the storage data associated with the access request at a lower-level cache of an integrated controller of the storage server in response to the access request without storing the storage data in an upper-level cache of a host module of the storage server, the integrated controller having a first interface coupled to the network and a second interface coupled to a storage subsystem.

The access request is a write request and the program further comprises code for sending metadata associated with the access request to the host module via a system interconnect while keeping the storage data at the integrated controller. A descriptor is generated at the host module using the metadata received from the integrated controller and sent to the integrated controller, wherein he program further comprises code for associating the descriptor to the storage data at the integrated controller to write the storage data to an appropriate storage location in the storage subsystem via the second interface of the integrated controller.

The access request is a read request and the storage data is obtained from the storage subsystem via the second interface. The computer program further comprises code for sending the storage data to the remote device via the first interface without first forwarding the storage data to the host module.

### BRIEF DESCRIPTION OF THE DRAWINGS

FIG. 1A illustrates an exemplary Direct Attached Storage (DAS) system.

FIG. 1B illustrates an exemplary Storage Area Network (SAN) system.

FIG. 1C illustrates an exemplary Network Attached Storage (NAS) system.

FIG. 2 illustrates an exemplary storage system that includes a storage server and a storage subsystem.

FIG. 3 illustrates exemplary data flow inside a storage server in response to read/write requests according to a conventional technology.

FIG. 4 illustrates a storage server according to one embodiment of the present invention.

FIG. 5 illustrates a BUCS or integrated controller according to one embodiment of the present invention.

FIG. 6 illustrates a process for performing a read request according to one embodiment of the present invention.

FIG. 7 illustrates a process for performing a write request according to one embodiment of the present invention.

### DETAILED DESCRIPTION OF THE INVENTION

The present invention relates to the storage server in a storage system. In one embodiment, the storage server is provided with a bottom-up cache structure (BUCS), where a lower-level cache is used extensively to process I/O requests. As used herein, the lower-level cache or memory refers to a cache or memory that is directly assigned to the CPU of a host module.

In such a storage server, storage data associated with I/O requests are kept at the lower-level cache as much as possible to minimize data traffic over the system bus or interconnect, as opposed to placing frequently used data at a higher-level cache as much as possible in the traditional top-down cache hierarchy. For storage read requests from a network, most data are directly passed to the network through the bottom level cache from the storage device such as a hard drive or RAID. Similarly for storage write requests from the network, most data are directly written to the storage device through the lower-level cache without copying them to the upper-level cache (also referred to as “main memory or cache”) as in existing systems.

Such data caching at a controller level dramatically reduces traffic on the system bus, such as PCI bus, resulting in a great performance improvement for networked data storage operations. In one experiment using Intel's IQ80310 reference board and Linux NBD (network block device), BUCS improves response time and system throughput over the traditional systems by as much as a factor of 3.

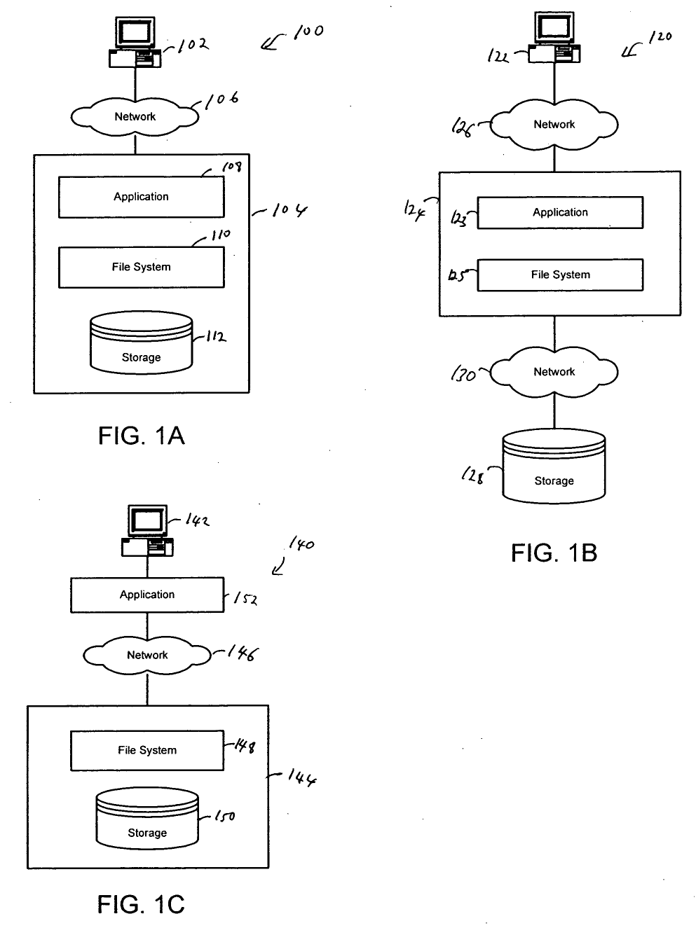

FIGS. 1A-1C illustrate various types of storage systems in an information infrastructure. FIG. 1A illustrates an exemplary Direct Attached Storage (DAS) system 100. The DAS system includes a client 102 that is coupled to a storage server 104 via a network 106. The storage server 104 includes an application 108 that uses or generates data, a file system 110 that manages data, and a storage subsystem 112 that stores data. The storage subsystem includes one or more storage devices that may be magnetic disk devices, optical disk devices, tape-based devices, or the like. The storage subsystem is a disk array device in one implementation.

DAS is a conventional method of locally attaching a storage subsystem to a server via a dedicated communication link between the storage subsystem and the server. A SCSI connection is commonly used to implement DAS. The server typically communicates with the storage subsystem using a block-level interface. The file system 110 residing on the server determines which data blocks are needed from the storage subsystem 112 to complete the file requests (or I/O requests) from the application 108.

FIG. 1B illustrates an exemplary Storage Area Network (SAN) system 120. The system 120 includes a client 122 coupled to a storage server 124 via a first network 126. The server 124 includes an application 123 and a file system 125. A storage subsystem 128 is coupled to the storage server 124 via a second network 130. The second network 130 is a network dedicated to connect storage subsystems, back-up storage subsystems, and storage servers. The second network is referred to as a Storage Area Network. SANs are commonly implemented with FICON™ or Fibre Channel. A SAN may be provided in a single cabinet or span a large number of geographic locations. Like DAS, the SAN server presents a block-level interface to the storage subsystem 128.

FIG. 1C illustrates an exemplary Network Attached Storage (NAS) system 140. The system 140 includes a client 142 coupled to a storage server 144 via a network 146. The server 144 includes a file system 148 and a storage subsystem 150. An application 152 is provided between the network 146 and the client 142. The storage server 144 with its own file system is directly connected to the network 146, which responds to industry-standard network file system interfaces like NFS and SMB/CIFS over LANs. The file requests (or I/O requests) are sent directly from the client to the file system 148. The NAS server 144 provides a file-level interface to the storage subsystem 150.

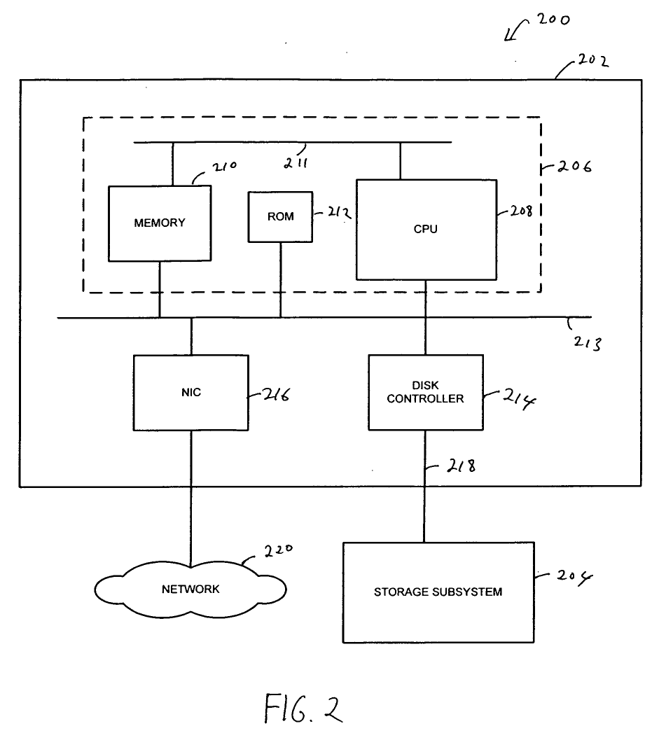

FIG. 2 illustrates an exemplary storage system 200 that includes a storage server 202 and a storage subsystem 204. The server 202 includes a host module 206 that includes a CPU 208, a main memory 210, and a non-volatile memory 212. In one implementation, the main memory and the CPU to connected to each other via a dedicated bus 211 to speed up the communication between these two components. The main memory is a RAM and is used as a main cache by the CPU. The non-volatile memory is a ROM in the present implementation and is used to store programs or codes executed by the CPU. The CPU is also referred to as the main processor.

The storage server 202 includes a main bus 213 (or system interconnect) that couples the module 206, a disk controller 214, and a network interface card (NIC) 216 together. In one implementation, the main bus 213 is a PCI bus. The disk controller is coupled to the storage subsystem 204 via a peripheral bus 218. In one implementation, the peripheral bus is a SCSI bus. The NIC is coupled to a network 220 and serves as a communication interface between the network and the storage server 202. The network 220 couples the server 202 to clients, such as the client 102, 122, or 142.

Referring to FIG. 1A to FIG. 2, while storage systems based on different technologies use different command sets and different message formats, the data flow through the network and data flow inside a server are similar in many respects. For a read request, a client sends to the server a read request including a command and metadata. The metadata provides information about the location and size of the requested data. Upon receiving the packet, the server validates the request and sends one or more packets containing the requested data to the client.

For a write request, a client sends to the server a write request including metadata and subsequently one or more packets containing the write data. The write data may be included in the write quest itself in certain implementations. The server validates the write request, copies the write data to the system memory, writes the data to the appropriate location in its attached storage subsystem, and sends an acknowledgement to the client.

The terms “client” and “server” are used broadly herein. For example, in the SAN system, the client sending the requests may be the server 124, and the server processing the requests may be the storage subsystem 128.

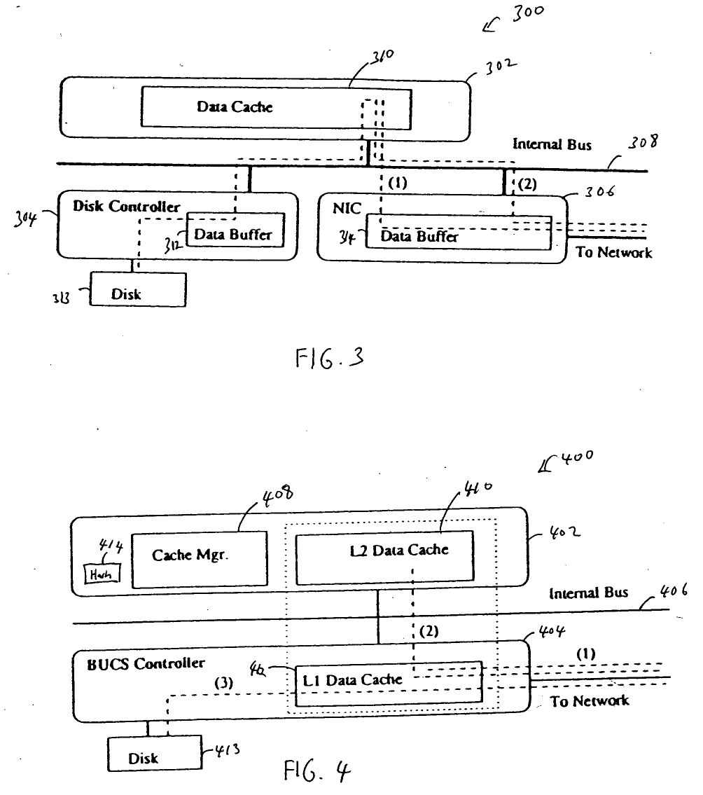

FIG. 3 illustrates exemplary data flow inside a storage server 300 in response to read/write requests according to a conventional technology. The server includes a host module 302, a disk controller 304, a NIC 306, and an internal bus (or main bus) 308 that couples these components. The module 302 comprises a main processor (not shown) and an upper-level cache 310. The disk controller 304 includes a first data buffer (or lower-level cache) 312 and is coupled to a disk 313 (or a storage subsystem). The disk/storage subsystem may be directly attached or linked to the server in the NAS or DAS system or may be coupled to the server via a network in the SAN system. The NIC 306 includes a second data buffer 314 and is coupled to a client (not shown) via a network. The internal bus 308 is a system interconnect and is a PCI bus in the present implementation.

In operation, upon receiving a read request from a client via the NIC 306, the module 302 (or an operation system of the server) determines whether or not the requested data are in the main cache 310. If so, the data in the main cache 310 is processed and sent to the client. If not, the module 302 invokes I/O operations to the disk controller 304 and loads the data from the disk 313 via the PCI bus 308. After the data are loaded to the main cache, the main processor generates headers and assembles response packets to be transferred to the NIC 306 via the PCI bus. The NIC then sends the packets to the client. As a result, data are moved across the PCI bus twice.

Upon receiving a write request from a client via the NIC 306, the module 302 first loads the data from NIC to the main cache 310 via the PCI bus and then stores the data into the disk 313 via the PCI bus. Data travel through the PCI bus twice for a write operation. Accordingly, the server 300 use the PCI bus extensively to complete the I/O requests under the conventional method.

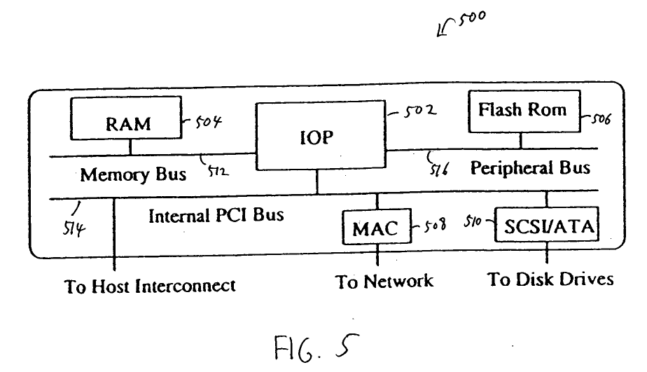

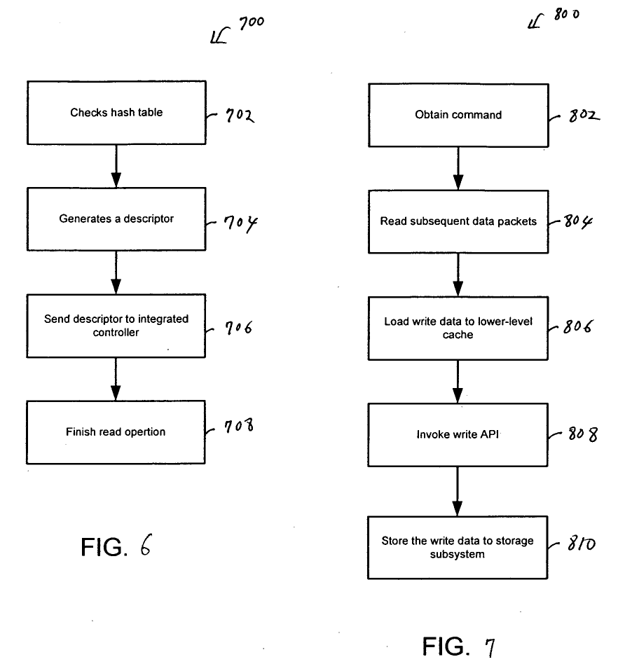

FIG. 4 illustrates a storage server 400 according to one embodiment of the present invention. The storage server 400 includes a host module 402, a BUCS controller 404, and an internal bus 406 coupling these two components. The module 402 includes a cache manager 408 and a main or upper-level cache 410. The BUCS controller 404 includes a lower-level cache 412. The BUCS controller is coupled to a disk 413 and a client (not shown) via a network. Accordingly, the BUCS controller combines the functions of the disk controller 304 and the NIC 306 and may be referred to as “an integrated controller.” The disk 413 may be in a storage subsystem that is directly attached to the server 400 or in a remote storage subsystem coupled to the server 400 via a network. The server 400 may be a server provided in a DAS, NAS, or SAN system depending on the implement.

In the BUCS architecture, data are kept at the lower-level cache as much as possible rather than moving them back and forth over the internal bus. Metadata that describe the storage data and commands that describe operations are transferred to the module 402 for processing while corresponding storage data are kept at the lower-level cache 412. Accordingly, much of the storage data are not transferred to the upper-level cache 410 via the internal or PCI bus 406 to avoid the traffic bottleneck. Since, the lower-level cache (or L-1 cache) is usually limited in size because of power and cost constraints, the upper-level cache (or L-2 cache) is used with the L-1 cache to process the I/O requests. The cache manager 408 manages this two-level hierarchy. In the present implementation, the cache manger resides in the kernel of the operation system of the server.

Referring back to FIG. 4, for a read request, the cache manager 408 checks if data are in the L-1 or L-2 cache. If data is in the L-1 cache, the module 402 prepares headers and invokes the BUCS controller to send data packets to the requesting client over the network through a network interface (see FIG. 5). If the data is in L-2 cache, the cache manager moves the data from the L-2 cache to L-1 cache to be sent to the client via the network. If the data is in the storage device or disk 413, the cache manager reads them out and loads them directly into the L-1 cache. In the present implementations, in both cases, the host module generates packet headers and transfers them to the BUCS controller. The controller assembles the headers and data and then sends the assembled packets to the requesting client.

For a write request, the BUCS controller generates a unique identifier for the data contained in a data packet and notifies the host of this identifier. The host then attaches metadata to this identifier in the corresponding previous command packet. The actual write data are kept in the L-1 cache and then written to the correct location in the storage device. Thereafter, the server sends an acknowledgment to the client. Accordingly, the BUCS architecture minimizes the transfer of large data over the PCI bus. Rather, only command portions of the 10 requests and metadata are transmitted to the host module via the PCI bus whenever possible.

As used herein, the term “meta-information” refers to administrative information in a request or packet. That is, the meta-information is any information or data that is not the actual read or write data in a packet (e.g., an I/O request). Accordingly, the meta-information may refer to the metadata, or header, or command portion, data identifier, or other administrative information, or any combination of the these elements.

In the storage server 400, a handler is provided to separate the command packets from data packets and forward the command packets to the host. The handler is implemented as part of program running on the BUCS controller according to the present implementation. The handler is stored in a non-volatile memory in the BUCS controller (see FIG. 5).

Preferably, a handler is provided for each network storage protocol since different protocols have their own specific message formats. For a newly created network connection, the controller 404 first tries to use all the handlers to determine which protocol the connection belongs to. For well-known ports that provide network storage services, specific handlers are dedicated to them to avoid handler search procedure at the beginning of a connection setup. Once the protocol is known and the corresponding handler is determined, the chosen handler will be used for the remaining data operations on the connection till the connection is terminated.

FIG. 5 illustrates a BUCS or integrated controller 500 according to one embodiment of the present invention. The controller 500 integrates the functions of a disk/sotrage controller and NIC. The controller includes a processor 502, a memory (also referred to as “lower-level cache”) 504, a non-volatile memory 506, a network interface 508, and a storage interface 510. A memory bus 512, which is a dedicated bus, connects the cache 504 to the processor 502 to provide a fast communication path for these components. An internal bus 514 couples the various components in the controller 500 and may be a PCI bus or PCI-X bus or other suitable types. A peripheral bus 516 couples the non-volatile memory 506 to the processor 502.

The non-volatile memory 506 is a Flash ROM to store firmware in the present implementation. The firmware stored in the Flash ROM includes the embedded OS code, the microcode relating to the functions of a storage controller, e.g., the RAID functional code, and some network protocol functions. The firmware can be upgraded using a host module of the storage server.

In the present implementation, the storage interface 510 is a storage controller chip that controls attached disks, the network interface is a network media access control (MAC) chip that transmits and receives packets.

The memory 504 is a RAM and provides L-1 cache. The memory 504 preferably is large, e.g., 1 GB or more. The memory 504 is a shared memory and is used in connection with the storage and network interfaces 508 and 510 to provide the functions of storage and network interfaces. In conventional server systems with separate storage interface (or Host Bus Adaptor) and NIC interface, the memory on storage HBA and the memory on NIC are physically isolated making it difficult to cross-access between peers. The marriage of HBA and NIC allows single copy of data to be referenced by different subsystems, resulting in high efficiency.

In the present implementation, the on-board RAM or memory 504 is partitioned into two parts. One part is reserved for on-board operation system (OS) and programs running on the controller 500. The other part, the major part, is used as L-1 cache of the BUCS hierarchy. Similarly, a partition of the main memory 410 of the module 402 is reserved for L-2 cache. The basic unit for caching is a file block for file system level storage protocols or a disk block for block-level storage protocols.

Using blocks as basic data unit for caching allows the storage server to maintain cache contents independently from network request packets. The cache manager 408 manages this two-level cache hierarchy. Cached data are organized and managed by a hashing table 414 that uses the on-disk offset of a data block as its hash key. The table 414 may be stored as part of the cache manager 408 or as a separate entity.

Each hash entry contains several items including the data offset on the storage device, the storage device identifier, size of the data, a link pointer for the hash table queue, a link pointer for the cache policy queue, a data pointer, and a state flag. Each bit in the state flag indicates different status such as whether the data is in L-1 or L-2 cache, whether the data is dirty or not, whether the entry and the data is locked during operations, etc.

Since the data may be stored non-continuously in the physical memory, an iovec (an I/O vector data structure) like structure to represent each piece of data. Each iovec structure stores the address and length of a piece of data that is continuous in memory and can be directly used by a scatter-gather DMA. The size of each hash entry is around 20 bytes in one implementation. If the average size of data represented by each entry is 4096 bytes, the hash entry cost is less than 5%. When a data block is added to L-1 or L-2 cache, a new cache entry is created by the cache manager, filled with metadata about this data block, and inserted into the appropriate place in the hash table.

The hash table may be maintained at different places according to the implementations: 1) the BUCS controller maintains it for both the L-1 cache and the L-2 cache in the on-board memory, 2) the host module maintains all the metadata in the main memory, 3) the BUCS controller and the host module maintain their own cached metadata individually.

In the preferred implementation, the second method is adopted to let the cache manager residing on the host module maintain metadata for both L-1 cache and L-2 cache. The cache manager sends different messages via APIs to the BUCS controller that acts as a slave to finish cache management tasks. The second method is preferred in the present implementation since network storage protocols are processed mostly at the host module side so the host module can more easily extract and acquire the metadata on the cached data than the BUCS controller. In other implementations, the BUCS controller may handle such a task.

A Lease Recently Used algorithm (LRU) replacement policy is implemented in the cache manager 408 to make a room for new data to be placed in a cache if cache full is obtained. Generally, most frequently used data are kept at L-1 cache. Once L-1 cache becomes full, the data that has not been accessed for the longest duration is moved from L-1 cache to L-2.cache. The cache manager updates the corresponding entry in the hash table to reflect such this data relocation. If the data is moved from L-2 cache to disk storage, the hash entry is unlinked from the hash table and discarded by the cache manager.

When a piece of data in L-2 cache is accessed again and needs to be placed in the L-1 cache, it is transferred back to the L-1 cache. When data in a L-2 cache needs to be written to the disk drives, the data are transferred to the BUCS controller to be written to disk drives directly by the BUCS controller, without polluting the L-1 cache. Such a write operation may go through buffers reserved as part of on-board OS RAM space.

Since BUCS replaces traditional storage controller and NIC with an integrated BUCS controller, interactions between the host OS and interface controllers are changed. In the present implementation, the host module treats the BUCS controller as an NIC with some additional functionalities, so that a new class of devices would not need to be created and keep the changes to OS kernel to minimum.

In the host OS, codes are added to export a plurality of APIs that can be utilized by other parts of the OS and also corresponding microcodes are provided in the BUCS controller. For each API, the host OS writes a specific command code and parameters to the registers of the BUCS controller, and the command dispatcher invokes the corresponding microcode on-board to finish desired tasks. The APIs may be stored in a non-volatile memory of the BUCS controller or loaded in the RAM as part of the host OS.

One API provided is the initialization API, bucs.cache.init( ). During the host module boot-up, the microcode on BUCS controller detects the memory on-board, reserves part of the memory for internal use, and keeps remaining part of the memory for L-1 cache. The host OS calls this API during initialization and gets the L-1 cache size. The host OS also detects the L-2 cache at boot time. After obtaining the information about L-1 cache and L-2 cache, the host OS setups a hash table and other data structures to finish the initialization.

FIG. 7 illustrates a process 700 for performing a read request according to one embodiment of the present invention. When the host needs to send data out for a read request from a client, it checks the hash table to find the location of the data (step 702). The data or part of the data can be in three possible places including the L-1 cache, the L-2 cache, and storage device. For each piece of data, the host generates a descriptor about its information and actions to be performed (step 704). For data in the L-1 cache, the processor 502 can send it out directly. For data in the L-2 cache, the host gives a new location in the L-1 cache for this data, moves the data from L-2 cache to the L-1 cache by DMA, and sends it out. For data on disk drives, the host finds a new location in the L-1 cache, guides the processor to read it from the disk drive, and places it in the L-1 cache. If the L-1 cache is full upon this disk operation, the host also decides which data in the L-1 cache are to be moved to the L-2 cache and provides the source and destination addresses for the data relocation. These descriptors are sent to the processor 502 via the API bucs.append.data( ) to perform actual operations (step 706). For each descriptor received, the processor checks the parameters and invokes different microcode to finish the read operation (step 708).

FIG. 8 illustrates a process 800 for performing a write request according to one embodiment of the present invention. For a write request from a client, the host module gets the command packet and designates a location in the L-1 cache (step 802). The host module using the cache manager may relocate infrequently accessed data in the L-1 cache to L-2 cache if L-1 cache lacks sufficient free space for the write data to be received. It then uses the API bucs.read.data( ) to read subsequent data packets following the command packet (step 804). The host OS will then guide the processor 502 to place the data in the L-1 cache directly (step 806).

When the host module wants to write data to disk drives directly, API bucs.write.data( ) is invoked (step 808). The host module provides a descriptor for the data to be written, including data location in the L-1 or L-2 cache, data size, and the location on the disk. The data is then transferred to the processor buffer that is a part of reserved RAM space for on-board OS and written to the disk by the processor 502 (step 810).

There are some other APIs defined in a BUCS system to assist main operations. For example, an API bucs.destage.L-1( ) is provided to destage data from the L-1 cache to the L-2 cache. An API bucs.prompt.L-2( ) is to move data from L-2 cache to L-1 cache. These APIs can be used by the cache manager to balance L-1 cache and L-2 cache dynamically when needed.

In a BUCS system, a storage controller and a NIC is replaced by a BUCS controller that integrates the functionalities of both and has a unified cache memory. This makes it possible to send out data to network once the data is read out from storage devices without involving I/O bus, host CPU and main memory. By placing frequently used data in the on-board cache memory (the L-1 cache), many read requests can be satisfied directly. A write request from a client can be satisfied by putting data in the L-1 cache directly without invoking any bus traffic. The data in the L-1 cache will be relocated to the host memory (the L-2 cache) when needed. With effective caching policy, this multi-level cache can provide a high speed and large-sized cache for networked storage data accesses.

The present invention has been described in terms of specific embodiments or implementations to provide enable those skilled in the art to practice the invention. The disclosed embodiments or implementations may be modified or altered without departing from the scope of the invention. For example, the internal bus may be a PCI-X bus or switch fabric, e.g., InfiniBand™. Accordingly, the scope of the invention should be defined using the appended claims.

1. A storage server coupled to a network, the server comprising:
a host module including a central processor unit (CPU) and a first memory;
a system interconnect coupling the host module; and
an integrated controller including a processor, a network interface device that is coupled to the network, a storage interface device coupled to a storage subsystem, and a second memory,
wherein the second memory defines a lower-level cache that temporarily stores storage data that is to be read out to the network or written to the storage subsystem, so that a read or write request can be processed without loading the storage data into an upper-level cache defined by the first memory.

2. The storage server of claim 1, wherein the second memory is shared by the network interface device and the storage interface device.

3. The storage server of claim 1, wherein the integrated controller includes:
an internal bus that couples the processor, the network interface device, and the storage interface device; and
a memory bus that couples the processor and the second memory.

4. The storage server of claim 3, wherein the system interconnect is a bus.

5. The storage server of claim 1, wherein the system interconnect is a switch-based device.

6. The storage server of claim 1, wherein storage data of an I/O request are kept in the lower-level cache while metadata of the I/O request are sent to the host module to generate a header for the I/O request.

7. The storage server of claim 6, wherein the I/O request is a read or write data.

8. The storage server of claim 1, further comprising:
a cache manager to manage the upper-level and lower-level caches.

9. The storage server of claim 8, wherein the cache manager is maintained by the host module.

10. The storage server of claim 9, wherein the cache manger maintains a hash table for managing data stored in the upper-level and lower-level caches.

11. The storage server of claim 1, wherein the storage server is provided in a Direct Attached Storage system.

12. The storage server of claim 1, wherein the storage server and the storage subsystem are provided within the same housing.

13. The storage server of claim 1, wherein the storage server is provided in a Network Attached Storage system or Storage Area Network system.

14. A method for managing a storage server that is coupled to a network, the method comprising:
receiving an access request at the storage server from a remote device via the network, the access request relating to storage data; and
storing the storage data associated with the access request at a lower-level cache of an integrated controller of the storage server in response to the access request without storing the storage data in an upper-level cache of a host module of the storage server, the integrated controller having a first interface coupled to the network and a second interface coupled to a storage subsystem.

15. The method of claim 14, wherein the access request is a write request, the method further comprising:
sending metadata associated with the access request to the host module via a system interconnect while keeping the storage data at the integrated controller.

16. The method of claim of claim 15, further comprising:
generating a descriptor at the host module using the metadata received from the integrated controller;
receiving the descriptor at the integrated controller;
associating the descriptor to the storage data at the integrated controller to write the storage data to an appropriate storage location in the storage subsystem via the second interface of the integrated controller.

16. The method of claim 14, wherein the access request is a read request and the storage data is obtained from the storage subsystem via the second interface.

17. The method of claim 16, further comprising:
sending the storage data to the remote device via the first interface without first forwarding the storage data to the host module.

18. An integrated controller for a storage controller provided in a storage server, the integrated controller comprising:
a processor to process data;
a memory to define a lower-level cache;
a first interface coupled to a remote device via a network;
a second interface coupled to a storage subsystem,
wherein the integrated controller is configured to temporarily store write data associated with a write request received from the remote device at the lower-level cache and then send the write data to the storage subsystem via the second interface without having stored the write data to an upper-level cache associated with a host module of the storage server.

19. A computer readable medium including a computer program for handling access requests received at a storage server from a remote device via a network, the computer program comprising:
code for receiving an access request at the storage server from the remote device via the network, the access request relating to storage data; and
storing the storage data associated with the access request at a lower-level cache of an integrated controller of the storage server in response to the access request without storing the storage data in an upper-level cache of a host module of the storage server, the integrated controller having a first interface coupled to the network and a second interface coupled to a storage subsystem.

20. The computer medium of claim 19, wherein the access request is a write request, the program further comprises:
code for sending metadata associated with the access request to the host module via a system interconnect while keeping the storage data at the integrated controller.

21. The computer medium of claim 20, wherein a descriptor is generated at the host module using the metadata received from the integrated controller and sent to the integrated controller, the program further comprises:
code for associating the descriptor to the storage data at the integrated controller to write the storage data to an appropriate storage location in the storage subsystem via the second interface of the integrated controller.

22. The computer medium of claim 21, wherein the access request is a read request and the storage data is obtained from the storage subsystem via the second interface.

23. The computer medium of claim 22, wherein the computer program further comprises:
code for sending the storage data to the remote device via the first interface without first forwarding the storage data to the host module.
